(19) United States
(12) Patent Application Publication
(10) Pub. No.: US 2026/0254922 A1
(43) Pub. Date: Aug. 27, 2026

(54) METHODS AND SYSTEMS FOR TAKING IMAGES DURING VIDEO CALLS

(71) Applicant: LINE Plus Corporation, Seongnam-si (KR)

(72) Inventors: Deok Yong AHN, Seongnam-si (KR); Hwan KIM, Seongnam-si (KR); Jaehyun LEE, Seongnam-si (KR); Min Jeong KIM, Seongnam-si (KR); Hee Won KIM, Seongnam-si (KR); Kyeung Min KIM, Seongnam-si (KR); Sanghyuk SUH, Seongnam-si (KR); Jeongrok KIM, Seongnam-si (KR); Tae Jeong LEE, Seongnam-si (KR); Jeong Hyeon KWON, Seongnam-si (KR); Ji Soo KIM, Seongnam-si (KR)

(73) Assignee: LINE Plus Corporation, Seongnam-si (KR)

(21) Appl. No.: 19/650,945

(22) Filed: Apr. 17, 2026

Related U.S. Application Data
(63) Continuation of application No. PCT/KR2024/011965, filed on Aug. 12, 2024.

(30) Foreign Application Priority Data
Oct. 17, 2023 (KR) 10-2023-0138882

(51) Int. Cl. H04N 7/14; G06T 11/60; H04L 51/04; H04L 51/10

(52) U.S. Cl. CPC H04N 7/141; G06T 11/60; H04L 51/04; H04L 51/10

(57) ABSTRACT

A method includes initiating a video call between the first user terminal and a second user terminal, the first user terminal being associated with a first user, the second user terminal being associated with a second user, and the first user and the second user being included in a chat room of an instant messaging application, transmitting a first image sequence captured by an image sensor of the first user terminal to the second user terminal during the video call, the first image sequence being transmitted at a first resolution, entering a multi-party photo capturing mode during the video call, and transmitting a first image captured by the image sensor to the second user terminal in the multi-party photo capturing mode, the first image being transmitted at a second resolution different from the first resolution.

### CROSS-REFERENCE TO RELATED APPLICATION

This application is a continuation of International Application No. PCT/KR2024/011965 filed on Aug. 12, 2024, which claims priority to Korean Patent Application No. 10-2023-0138882 filed on Oct. 17, 2023, the entire contents of which are herein incorporated by reference.

### BACKGROUND

### Field

Aspects of some example embodiments relate to a method and a system for capturing an image during a video call, and specifically, to a method and an apparatus for transmitting an image sequence transmitted during a video call, and an image for generating a composite image, to different user terminals at different resolutions, and outputting the generated composite image.

### Description of Related Art

Recently, due to the spread of mobile devices such as smartphones and the development of the Internet, instant messaging applications capable of voice calls as well as video calls among a plurality of users are widely used. Meanwhile, demand for a so-called ‘photo booth’, which prints and provides photos captured together with several people offline, is steadily increasing.

However, because an image capturing function provided in an existing video call providing service is merely capturing a screen of a specific moment during a video call, it is difficult to provide images to which various formats, concepts, photo themes, and the like, are applied to a user, and it is difficult to acquire a higher-resolution composite image.

### SUMMARY

Existing image capturing services experience difficulty in providing an image with which a user is satisfied as compared to images captured in a “photo booth.” The present disclosure provides a method of capturing an image during a video call, a computer-readable non-transitory storage medium storing instructions, and a system (apparatus) for addressing the above challenges.

The present disclosure may be implemented in various ways including a method, a system (apparatus), or a computer-readable non-transitory storage medium storing instructions.

In some example embodiments, a method performed by at least one processor of a first user terminal is provided. The method includes initiating a video call between the first user terminal and a second user terminal, the first user terminal being associated with a first user, the second user terminal being associated with a second user, and the first user and the second user being included in a chat room of an instant messaging application, transmitting a first image sequence captured by an image sensor of the first user terminal to the second user terminal during the video call, the first image sequence being transmitted at a first resolution, entering a multi-party photo capturing mode during the video call, and transmitting a first image captured by the image sensor to the second user terminal in the multi-party photo capturing mode, the first image being transmitted at a second resolution different from the first resolution.

In some example embodiments, the method may further include outputting a composite image on a display of the first user terminal, the first image and a second image being composited in the composite image, the first image including the first user, and the second image including the second user.

In some example embodiments, the second resolution is higher than the first resolution.

In some example embodiments, the first resolution is greater than or equal to a first minimum resolution, the second resolution is greater than or equal to a second minimum resolution, and the second minimum resolution is higher than the first minimum resolution.

In some example embodiments, the method may further include transmitting a second image sequence captured by the image sensor to the second user terminal after the entering the multi-party photo capturing mode and before capturing the first image, the second image sequence being transmitted to the second user terminal at a third resolution, and the third resolution being different from both the first resolution and the second resolution.

In some example embodiments, the third resolution is higher than the first resolution and lower than the second resolution.

In some example embodiments, the first resolution is greater than or equal to a first minimum resolution, the second resolution is greater than or equal to a second minimum resolution, the third resolution is greater than or equal to a third minimum resolution, the third minimum resolution is higher than the first minimum resolution, and the second minimum resolution is higher than the third minimum resolution.

In some example embodiments, the first resolution is less than or equal to the third minimum resolution, and the third resolution is less than or equal to the second minimum resolution.

In some example embodiments, the method may further include outputting a video call screen on a display of the first user terminal after the initiating the video call and before the entering the multi-party photo capturing mode, and outputting a multi-party photo capturing preview screen on the display after the entering the multi-party photo capturing mode and before capturing the first image, the multi-party photo capturing preview screen has a higher video quality than the video call screen.

In some example embodiments, the first resolution and the third resolution are determined based on a network bandwidth associated with the first user terminal, the third resolution is higher than the first resolution, and a frame rate of the second image sequence is lower than a frame rate of the first image sequence.

In some example embodiments, the transmitting the second image sequence may include determining a temporary resolution associated with the second image sequence based on a network bandwidth associated with the first user terminal, and increasing a resolution of the second image sequence from the temporary resolution to the third resolution and decreasing a frame rate of the second image sequence in response to determining that the temporary resolution is lower than a minimum resolution.

In some example embodiments, the method may further include receiving a user input selecting a multi-party photo capturing button from the first user based on the entering the multi-party photo capturing mode, capturing the first image using the image sensor, the first image including the first user, receiving a second image from the second user terminal, the second image including the second user, and generating a composite image by compositing the first image and the second image.

In some example embodiments, a resolution of the composite image is higher than the first resolution.

In some example embodiments, the method may further include transmitting the composite image to the second user terminal through the chat room.

In some example embodiments, the method may further include generating metadata of a Voice over Internet Protocol (VoIP) call packet, the metadata including data corresponding to the composite image, and transmitting the metadata to the second user based on the video call, the metadata being metadata in a protocol of a VoIP call channel connected to the first user and the second user.

In some example embodiments, the entering the multi-party photo capturing mode may include entering a specific sub-group among a plurality of sub-groups associated with multi-party photo capturing, the second user being included in a same specific sub-group as the first user.

In some example embodiments, a maximum number of users associated with participation in multi-party photo capturing is less than a maximum number of users associated with participation in the video call.

In some example embodiments, the method may further include displaying the first image sequence on a first area of a display of the first user terminal in response to determining that a number of users participating in the multi-party photo capturing mode is less than or equal to a first number of people, the displaying the first image sequence being performed based on the entering the multi-party photo capturing mode, and displaying a second image sequence received from the second user terminal on a second area of the display.

In some example embodiments, a non-transitory computer-readable storage medium may be provided. The non-transitory computer-readable storage medium stores instructions that, when executed by at least one processor of a computer, cause the at least one processor to perform the method(s) described above.

In some example embodiments, a first user terminal may include a memory, an image sensor, and at least one processor connected to the memory and configured to execute at least one computer-readable program included in the memory to cause the first user terminal to initiate a video call between the first user terminal and a second user terminal, the first user terminal being associated with a first user, the second user terminal being associated with a second user, and the first user and the second user being included in a chat room of an instant messaging application, transmit a first image sequence captured by the image sensor to the second user terminal during the video call, the first image sequence being transmitted at a first resolution, enter a multi-party photo capturing mode during the video call, and transmit a first image captured by the image sensor to the second user terminal in the multi-party photo capturing mode, the first image being transmitted at a second resolution different from the first resolution.

In some example embodiments of the present disclosure, in the multi-party photo capturing preview screen, an image sequence captured by an image sensor of each user terminal may be composited and a composite image sequence may be displayed, and a user may prepare a location, a pose, an action, and the like, of the user to be displayed on the composite image in advance through the composite image sequence.

In some example embodiments of the present disclosure, a network bandwidth associated with a plurality of user terminals may be efficiently used.

In some example embodiments of the present disclosure, by adjusting a frame rate when an image sequence is transmitted and received, it may be guaranteed (or more likely) that the image sequence and/or an image are transmitted and received at a higher resolution even if a bandwidth is not sufficient.

In some example embodiments of the present disclosure, an image used for generating a composite image may be captured/transmitted at a higher resolution, and thus a higher-resolution composite image may be generated.

In some example embodiments of the present disclosure, an image to which various photo themes are applied may be provided.

In some example embodiments of the present disclosure, even if a plurality of users capture images in different environments, an image as if photos were captured in one space may be generated.

In some example embodiments of the present disclosure, a host may check the number of feedbacks (e.g., a quantity of feedback indications) given to a photo theme by guest(s) through a host terminal, and thus opinions of a guest may be reflected when a photo theme to be applied to a photo booth image is selected.

In some example embodiments of the present disclosure, because users take a posture according to a pose guide displayed on a display, postures of the users may not be misaligned even if photo capturing timings of the users are slightly different.

The effects of the present disclosure are not limited to the above-mentioned effects, and other effects not mentioned will be clearly understood by a person of ordinary skill in the art to which the present disclosure belongs (hereinafter, referred to as an ‘ordinary skilled person’) from the description of the claims.

### BRIEF DESCRIPTION OF THE DRAWINGS

Some example embodiments of the present disclosure will be described with reference to the accompanying drawings described below, where like reference numerals indicate like elements, but are not limited thereto.

FIG. 1 illustrates an example in which a photo booth image including a plurality of users is displayed on a display of a user terminal according to some example embodiments of the present disclosure.

FIG. 2 is an overview diagram illustrating a configuration in which an information processing system is communicatively connected to a plurality of user terminals to provide an image capturing service during a video call according to some example embodiments of the present disclosure.

FIG. 3 is a block diagram illustrating internal configurations of a user terminal and an information processing system according to some example embodiments of the present disclosure.

FIG. 4 is a block diagram illustrating an internal configuration of a processor of a user terminal according to some example embodiments of the present disclosure.

FIG. 5 illustrates resolutions of an image or an image sequence transmitted and received between users according to some example embodiments of the present disclosure.

FIG. 6 illustrates an operation of entering a multi-party photo capturing mode at a host terminal side according to some example embodiments of the present disclosure.

FIG. 7 illustrates an operation of entering a multi-party photo capturing mode at a guest terminal side according to some example embodiments of the present disclosure.

FIG. 8 illustrates an example in which a guest gives feedback to a photo theme according to some example embodiments of the present disclosure.

FIG. 9 illustrates an example in which a photo booth image is displayed according to some example embodiments of the present disclosure.

FIG. 10 illustrates a video call group associated with a video call and a sub-group associated with a multi-party photo capturing mode according to some example embodiments of the present disclosure.

FIG. 11 is a flowchart illustrating a process for generating a composite image according to some example embodiments of the present disclosure.

FIG. 12 is a flowchart illustrating a method of capturing an image during a video call according to some example embodiments of the present disclosure.

### DETAILED DESCRIPTION

Hereinafter, specific details for implementation of the present disclosure will be described in detail with reference to the accompanying drawings. In some example embodiments, in the following description, specific descriptions of well-known functions or configurations will be omitted to avoid obscuring the core aspects of the present disclosure.

In the accompanying drawings, identical (or similar) or corresponding components are given identical (or similar) reference numerals. Additionally, in the description of the following examples, overlapping descriptions of identical (or similar) or corresponding components may be omitted. However, even if a description of a component is omitted, it is not intended that such a component is not included in any example.

Advantages and features of the disclosed examples and methods of achieving the advantages and the features will become apparent with reference to the examples described below in conjunction with the accompanying drawings. For example, the present disclosure is not limited to the examples disclosed below and may be implemented in various different forms, and the present examples are only provided to make the present disclosure complete and to completely inform an ordinary skilled person of the scope of the inventive concepts.

Terms used in the present specification will be briefly described, and the disclosed examples will be described in detail. As for the terms used in the present specification, general terms currently widely used are selected as much as possible while considering functions in the present disclosure, but the terms may vary depending on intentions of a technician working in the related field, precedents, the emergence of new technologies, and the like. For example, in a specific case, there are also terms selected by an applicant, and in a specific case, meanings of the terms will be described in detail in a description part of a corresponding example. Therefore, the terms used in the present disclosure should be defined based on meanings of the terms and overall contents of the present disclosure, rather than simple names of the terms.

Expressions in a singular form in the present specification include expressions in a plural form unless clearly specified otherwise in context. For example, expressions in a plural form include expressions in a singular form unless clearly specified otherwise in context. Throughout the specification, when a part includes a component, the part may further include other components rather than excluding other components unless specifically stated to the contrary.

Additionally, a term ‘module’ or ‘unit’ used in the specification means a software or hardware component, and a ‘module’ or ‘unit’ performs certain roles. For example, a ‘module’ or ‘unit’ is not limited to software or hardware. A ‘module’ or ‘unit’ may be configured to reside on an addressable storage medium or may be configured to be executed by one or more processors. Therefore, for example, a ‘module’ or ‘unit’ may include components such as software components, object-oriented software components, class components, and task components, and at least one of processes, functions, attributes, procedures, subroutines, segments of program code, drivers, firmware, microcode, circuitry, data, databases, data structures, tables, arrays, or variables. Functions provided in components and ‘modules’ or ‘units’ may be combined into a smaller number of components and ‘modules’ or ‘units’ or may be further separated into additional components and ‘modules’or ‘units’.

According to some example embodiments of the present disclosure, a ‘module’ or ‘unit’ may be implemented by processing circuitry and a memory. The term “processing circuitry,” as used in the present disclosure, may refer to, for example, hardware including logic circuits; a hardware/software combination such as a processor executing software; or a combination thereof. For example, the processing circuitry should be interpreted broadly to include, but is not limited to, a general-purpose processor, a Central Processing Unit (CPU), a microprocessor, an Arithmetic Logic Unit (ALU), a Graphics Processing Unit (GPU), a Digital Signal Processor (DSP), a controller, a microcontroller, a state machine, an Application Specific Integrated Circuit (ASIC), a Programmable Logic Device (PLD), a Field Programmable Gate Array (FPGA), a System-on-Chip (SoC), a programmable logic unit, and the like. “Processing circuitry” may refer to a combination of processing devices, for example, a combination of a DSP and a microprocessor, a combination of a plurality of microprocessors, a combination of one or more microprocessors in conjunction with a DSP core, or any other combination of such configurations. For example, a ‘memory’ should be interpreted broadly to include any electronic component capable of storing electronic information. A ‘memory’ may refer to various types of processor-readable media such as Random Access Memory (RAM), Read-Only Memory (ROM), Non-Volatile Random Access Memory (NVRAM), Programmable Read-Only Memory (PROM), Erasable Programmable Read-Only Memory (EPROM), Electrically Erasable PROM (EEPROM), flash memory, magnetic or optical data storage, registers, hard disk, a removable disk, a CD ROM, and the like. A memory is said to be in an electronic communication state with a processor if the processor may read information from the memory and/or write information to the memory. A memory integrated into a processor is in an electronic communication state with the processor.

In the present disclosure, a ‘user’ may refer to a user of an instant messaging application included in a chat room of the instant messaging application, and/or may refer to a user conducting a video call with another user in the chat room. Alternatively, a ‘user’ may refer to an image in which such a user is displayed/depicted or a partial area of an image.

In the present disclosure, a ‘user account’ may represent an account created and used by a user in an instant messaging application or data related to the account. For example, a user account of an instant messaging application may refer to a user using the instant messaging application. Similarly, a user using an instant messaging or a chat room capable of instant messaging may refer to a user account of an instant messaging application.

In the present disclosure, a ‘chat room’ may refer to a virtual space or group that may be generated in an instant messaging application installed in a computing device, in which one or more users (or user accounts) may participate. For example, one or more user accounts may participate or be included in a chat room to exchange various forms of messages, files, and the like, with each other. For example, a Voice over Internet Protocol (VoIP) voice call function, a VoIP video call function, a live broadcasting function (VoIP real-time video transmission function), and/or a multimedia content generation function may be provided in a chat room, so that voice calls, video calls, video streaming, multimedia content transmission, and the like, between user accounts may be performed.

In the present disclosure, a ‘host’ may refer to a user who requests multi-party photo capturing among users conducting a video call or a user who receives host authority from an existing host, and a ‘host terminal’may refer to a user terminal associated with a host.

In the present disclosure, a ‘guest’ may refer to a user who accepts a multi-party photo capturing request of a host and enters a multi-party photo capturing mode, and a ‘guest terminal’ may refer to a user terminal associated with a guest.

In the present disclosure, unless otherwise specified, a ‘user’ may refer to a host and/or a guest, and a ‘user terminal’may refer to a host terminal and/or a guest terminal.

In the present disclosure, a ‘photo booth image’ may refer to a final result image of a multi-party photo capturing mode, including one or more composite images.

In the present disclosure, ‘video quality’ may refer to a resolution, a bitrate, a frame rate, and/or a color depth of a video. For example, when a specific screen has a higher video quality than another screen, the specific screen may have a higher frame rate than another screen.

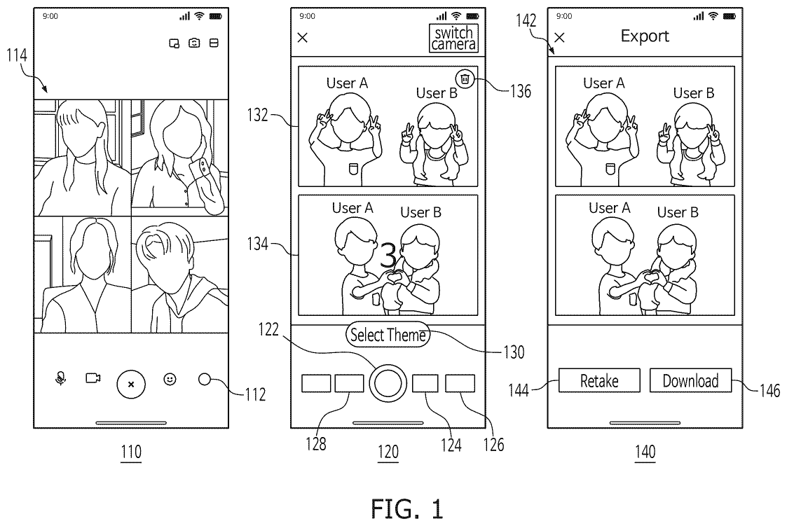

FIG. 1 illustrates an example in which a photo booth image 142 including a plurality of users is displayed on a display (e.g., a display screen) of a user terminal according to some example embodiments of the present disclosure. A first operation 110 may indicate a video call screen 114 conducted among a plurality of user terminals associated with a plurality of users. In each of a plurality of user terminals, a screen including each user may be displayed in an arbitrary (or different) size at an arbitrary (or different) position on a display, and the video call screen 114 may not be identically displayed on all user terminals. In some example embodiments, a video call may be initiated and conducted among each of a plurality of user terminals associated with a plurality of users included in a chat room of an instant messaging application.

Although 4 users are illustrated as conducting a video call in FIG. 1, it is not limited thereto, and an arbitrary (or different) number of users (for example, 6 people) who are at least a part of users (for example, 8 people) included in a chat room of an instant messaging application may simultaneously (or contemporaneously) conduct a video call.

In some example embodiments, during a video call, an image sequence captured by an image sensor of a user terminal participating in the video call may be transferred to another user terminal participating in the video call. The video call screen 114 may be a screen on which an image sequence captured by an image sensor of a user terminal and an image sequence received from another user terminal are displayed.

An image sequence captured in the user terminal during a video call may be transmitted to another user terminal at a first resolution. The first resolution may be greater than or equal to a predetermined (or alternatively, given) first minimum (or lowest) resolution (for example, Quarter Video Graphics Array (QVGA)), and may be determined based on a network bandwidth associated with a user terminal. For example, when a network bandwidth associated with a user terminal is sufficient, an image sequence may be transmitted at a resolution higher than a first minimum (or lowest) resolution, but when a network bandwidth is lower, an image sequence may be transmitted at the first minimum (or lowest) resolution. As discussed herein, images (or image sequences or videos) may be transmitted at a given quality (e.g., a given resolution). According to some example embodiments, the quality (e.g., resolution) at which the images are transmitted may be the same as (or similar to) or different from the quality (e.g., resolution) at which the images are captured (e.g., by an image sensor). For example, the images may be downscaled, etc., relative to a quality at which the images were captured prior to transmission, for example, in a scenario in which an amount of bandwidth available to a user terminal is insufficient for transmission of the images at the quality level at which the images were captured.

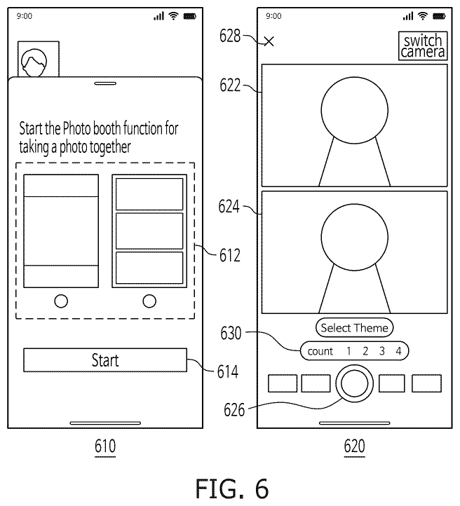

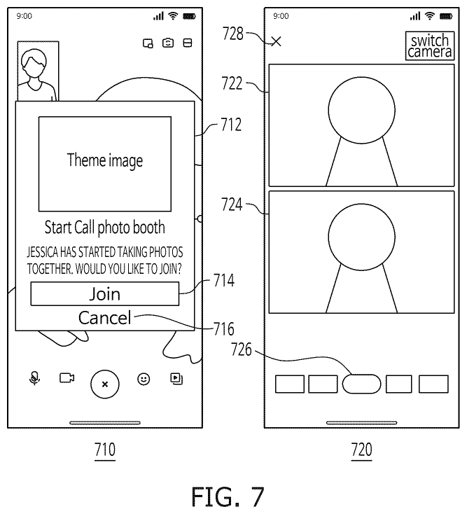

In the first operation 110, a user among a plurality of users conducting a video call selects a multi-party photo capturing mode entry button 112 through a touch input or the like, thereby entering a multi-party photo capturing mode. Thereafter, a multi-party photo capturing request may be transmitted to another user conducting a video call. Another user conducting a video call may enter a multi-party photo capturing mode by agreeing to a multi-party photo capturing request. A specific process of entering a multi-party photo capturing mode will be described later in detail with reference to FIG. 6 and FIG. 7.

A second operation 120 illustrates an example where a composite image 132 in which an image including a first user (indicated as user A) and an image including a second user (indicated as user B) are composited, and a multi-party photo capturing preview screen 134 (also referred to herein as a “preview screen 134”) are displayed on the display after a plurality of user terminals enter a multi-party photo capturing mode.

In some example embodiments, in response to a user (host) who selects a multi-party photo capturing mode entry button 112 in a first operation 110 selecting the multi-party photo capturing button 122, a composite image 132 may be generated and displayed on a display. After the composite image 132 is generated, a multi-party photo capturing preview screen 134 for generating a next composite image may be displayed on a display. In the multi-party photo capturing preview screen 134, an image sequence captured by an image sensor of each user terminal is composited and a composite image sequence is displayed, and a user may prepare a location, a pose, an action, and the like, of the user to be displayed on a composite image in advance through the composite image sequence. Thereafter, a composite image may be generated by a user selecting the multi-party photo capturing button 122 again. As illustrated, in response to a user selecting the multi-party photo capturing button 122, a timer (‘3’, ‘2’, ‘1’) (e.g., a countdown) is displayed on the multi-party photo capturing preview screen 134, and a composite image may be generated when a time of a timer elapses (e.g., reaches zero).

In another example, after a composite image 132 is generated by a user selecting a multi-party photo capturing button 122, another composite image may be sequentially generated whenever a predetermined (or alternatively, given) time (for example, 5 seconds) elapses. This process may be repeated until a predetermined (or alternatively, given) number of composite images are generated, or until a user stops photo capturing.

A composite image 132 may be generated in a host terminal. For example, in response to receiving a user input selecting a multi-party photo capturing button 122, a host terminal may capture a first image including a host by using an image sensor, receive a second image including a guest from a guest terminal, and then generate the composite image 132 by compositing the first image and the second image. The second image may be transmitted to a host terminal at a second resolution, and the second resolution may be greater than or equal to a predetermined (or alternatively, given) second minimum (or lowest) resolution (for example, High Definition (HD) 720). In some example embodiments, the second resolution may be a predetermined (or alternatively, given) resolution.

A composite image sequence displayed on a multi-party photo capturing preview screen 134 may be generated in each user terminal that has entered a multi-party photo capturing mode. For example, a user terminal may transmit an image sequence captured by an image sensor to another user terminal, and each user terminal may generate a composite image sequence using a received image sequence and an image sequence captured by an image sensor. In such examples, an image sequence for generating a composite image sequence may be transmitted to another user terminal at a third resolution.

The third resolution may be greater than or equal to a predetermined (or alternatively, given) third minimum (or lowest) resolution (for example, VGA), and may be determined based on a network bandwidth associated with a user terminal. For example, when a network bandwidth associated with a user terminal is sufficient, an image sequence may be transmitted at a resolution higher than a third minimum (or lowest) resolution, but when a network bandwidth is lower, an image sequence may be transmitted at the third minimum (or lowest) resolution.

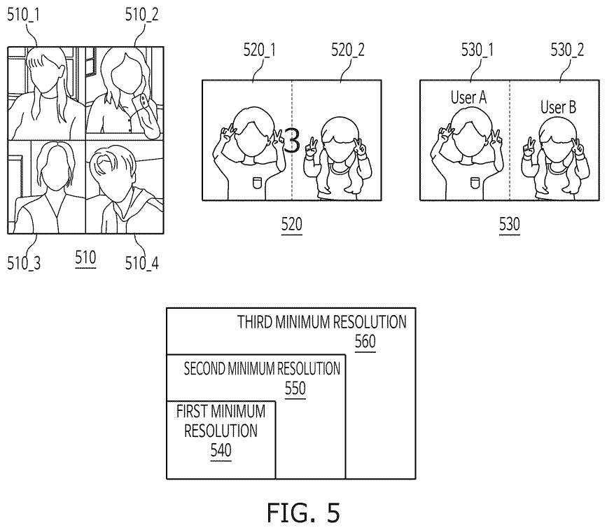

In some example embodiments, a third minimum (or lowest) resolution may be different from a first minimum (or lowest) resolution at which an image sequence for conducting a video call is transmitted and a second resolution (or a second minimum (or lowest) resolution) at which an image for generating a composite image is transmitted. For example, a third minimum (or lowest) resolution may be higher than a first minimum (or lowest) resolution and lower than a second resolution (or a second minimum (or lowest) resolution). This will be described later in detail with reference to FIG. 5.

A multi-party photo capturing button 122 may be activated only in a user terminal of a user (host) who selected a multi-party photo capturing mode entry button 112 in a first operation 110, or may be displayed only for a corresponding user terminal. In some example embodiments, the multi-party photo capturing button 122 may be deactivated when another user selects a camera off button 128 to turn off a camera.

In some example embodiments, a user may select an effect button 124 to apply various visual effects to a composite image 132 and/or a preview screen 134. Specifically, when a user selects the effect button 124, a list of effects applicable to the composite image 132 and/or the preview screen 134 is displayed on the display, and by a user selecting one or more effects from an effect list, a selected effect may be applied to the composite image 132 and/or the preview screen 134 included. For example, it may be confirmed that an effect displaying user information (such as user A, user B, and the like, an identifier (ID), a chat name (or display name), a nickname, and the like, of each user in an instant messaging application) is applied to each of the composite image 132 and the preview screen 134 of FIG. 1.

An effect applicable to a composite image 132 and/or a preview screen 134 may include a decoration element (for example, a flower drawing, a firecracker effect, and the like), an information element (for example, information of each user included in a composite image, a capturing date and time, text, and the like), an image attribute element (for example, brightness, saturation, and the like, of a composite image), and the like, but is not limited thereto.

After one or more effects are selected, a user may move an applied effect to a desired location by drag & drop (e.g., a drag and drop interface interaction) and the like, or apply an applied effect to a desired size using a gesture such as a spread or a pinch (e.g., a spread or pinch interface interaction).

In some example embodiments, a user may select a gallery button 126 associated with a captured image. When a user selects the gallery button 126, a user may check an image (for example, a previously captured composite image, a photo booth image, and the like) stored in a user terminal. For example, a user may select an image stored in a user terminal and add a selected image to a photo booth image.

In some example embodiments, a user may select a theme button 130 associated with a theme to be applied to a photo booth image 142. For example, when a user selects the theme button 130, a list of themes applicable to the photo booth image 142 is displayed on a display, and by a user selecting a theme from a theme list, a photo booth image to which a selected theme is applied may be displayed on a display. In some example embodiments, a separate theme may be selected and applied to each of composite images included in a photo booth image. In some example embodiments, a user may select a theme in advance before a multi-party photo capturing button 122 is selected.

In some example embodiments, a user may delete a composite image 132 by selecting a delete button 136 corresponding to the composite image 132. After the composite image 132 is deleted, a user may generate a composite image newly to replace a deleted composite image.

In some example embodiments, a delete button 136 may be activated only in a user terminal of a user (host) who selected a multi-party photo capturing mode entry button 112 in a first operation 110, or may be displayed only for a corresponding user terminal. Alternatively, the delete button 136 is activated for all users who have entered a multi-party photo capturing mode, but a corresponding composite image may be deleted only when a majority of all users selects a delete button for the same composite image (or similar composite images).

A third operation 140 may indicate an example in which a photo booth image 142 including a plurality of composite images in which a plurality of users are respectively included is displayed on a display of a user terminal in response to completion of image capturing in a second operation 120.

Although a photo booth image 142 is illustrated as including 2 composite images in FIG. 1, it is not limited thereto, and an arbitrary (or different) number of composite images may be included in the photo booth image 142 at arbitrary (or different) positions and arbitrary (or different) sizes. For example, a user may set the number of composite images to be captured, positions and sizes of each of composite images, and the like, and a composite image may be generated by capturing images of each user a number of times corresponding to the set number of composite images.

A user may recapture a photo booth image 142 by selecting a recapture button 144. In some example embodiments, in response to a majority of users included in the photo booth image 142 selecting the recapture button 144, a multi-party photo capturing preview screen may be output on a display again. In some example embodiments, a recapture button 144 is activated only for a host, and in response to a host selecting the recapture button 144, a multi-party photo capturing preview screen may be output on a display again.

A user may save a photo booth image 142 in a user terminal by selecting a download button 146.

Sizes or positions of images, buttons, and the like, illustrated and described in FIG. 1 are examples, and are not limited thereto. For example, some buttons may be added or omitted, or may be configured with sizes and positions different from those illustrated. According to some example embodiments, the video call screen 114 and/or the multi-party photo capturing preview screen 134 may be included in one or more Graphical User Interfaces (GUIs). According to some example embodiments the operations 110, 120 and/or 140 may be performed using and/or by manipulating the GUIs.

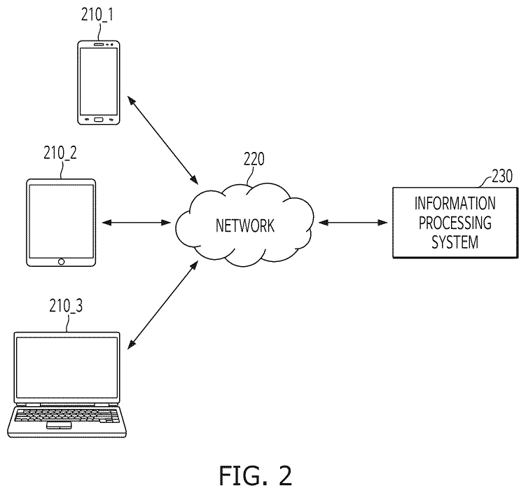

FIG. 2 is an overview diagram illustrating a configuration in which an information processing system 230 is communicatively connected to a plurality of user terminals 210_1, 210_2, and 210_3 to provide an image capturing service during a video call according to some example embodiments of the present disclosure. The information processing system 230 may include system(s) capable of providing an instant messaging service, system(s) capable of providing a social network service, and/or system(s) capable of providing an image capturing service during a video call. In some example embodiments, the information processing system 230 may include one or more server devices and/or databases capable of storing, providing, and executing computer-executable programs (for example, a downloadable application) and data related to an instant messaging service, a social network service, and/or an image capturing service during a video call, or one or more distributed computing devices and/or distributed databases based on a cloud computing service. For example, the information processing system 230 may include separate systems (for example, servers) for an instant messaging service, a social network service, and/or an image capturing service during a video call. According to some example embodiments, operations described herein as being performed by each of the plurality of user terminals 210_1, 210_2, and/or 210_3, and/or the information processing system 230 may be performed by processing circuitry.

An instant messaging service, an image capturing service during a video call, and the like, provided by the information processing system 230 may be provided to a user through an instant messaging application, and the like, installed in each of a plurality of user terminals 210_1, 210_2, and 210_3. For example, an instant messaging service may include a text messaging service, a voice messaging service, a video call service, a voice call service, a video streaming service, a social network service, an image capturing service during a video call, and the like, between users of an instant messaging application.

A plurality of user terminals 210_1, 210_2, and 210_3 may communicate with the information processing system 230 through a network 220. The network 220 may be configured to enable communication between the plurality of user terminals 210_1, 210_2, and 210_3 and the information processing system 230. A network 220 may be configured with a wired network such as Ethernet, Power Line Communication, a telephone line communication device, and RS-serial communication, a mobile communication network, a wireless network such as WLAN (Wireless Local Area Network (LAN)), Wi-Fi, Bluetooth, and ZigBee, or a combination thereof, depending on an installation environment. A communication method is not limited, and a short-range wireless communication between user terminals 210_1, 210_2, and 210_3 as well as a communication method utilizing a communication network (for example, a mobile communication network, a wired Internet, a wireless Internet, a broadcasting network, a satellite network, and the like) that the network 220 may include may also be used.

Although a mobile phone terminal 210_1, a tablet terminal 210_2, and a PC terminal 210_3 are illustrated as examples of a user terminal in FIG. 2, it is not limited thereto, and user terminals 210_1, 210_2, and 210_3 may be any computing device capable of wired and/or wireless communication and capable of installing and executing an instant messaging application, and the like. For example, a user terminal may include a smartphone, a mobile phone, a navigation device, a computer, a laptop computer, a digital broadcasting terminal, a PDA (Personal Digital Assistants), a PMP (Portable Multimedia Player), a tablet Personal Computer (PC), a game console, a wearable device, an IoT (Internet of Things) device, a VR (Virtual Reality) device, an AR (Augmented Reality) device, and the like. For example, although 3 user terminals 210_1, 210_2, and 210_3 are illustrated as communicating with the information processing system 230 through a network 220 in FIG. 2, it is not limited thereto, and a different number of user terminals may be configured to communicate with the information processing system 230 through the network 220.

In some example embodiments, each of user terminals 210_1, 210_2, and 210_3 may receive information or data from another user terminal or transmit information or data to another user terminal through the network 220. For example, each of user terminals 210_1, 210_2, and 210_3 may transmit and receive a user input selecting a multi-party photo capturing button, a user input selecting a multi-party photo capturing mode exit button, an image including a user, a user input selecting one of a plurality of photo themes, and/or an image sequence, and the like.

According to some example embodiments, the network bandwidth referred to herein may be a bandwidth of a communication link between the user terminal and the information processing system 230 through the network 220. For example, when the user terminals communicate with each other via the information processing system 230 (e.g., a relay server), the bandwidth may refer to a bandwidth of a connection between each user terminal and the information processing system 230. In some example embodiments, when the user terminals communicate with each other via a peer-to-peer connection, the bandwidth may refer to a bandwidth of a direct connection between the user terminals. According to some example embodiments, the bandwidth may vary according to the number of user terminals participating in the video call and/or the multi-party photo capturing mode. For example, when a greater number of user terminals enter the multi-party photo capturing mode, a per-terminal share of available bandwidth may decrease, and accordingly, the resolution of image sequences transmitted between user terminals may be adjusted.

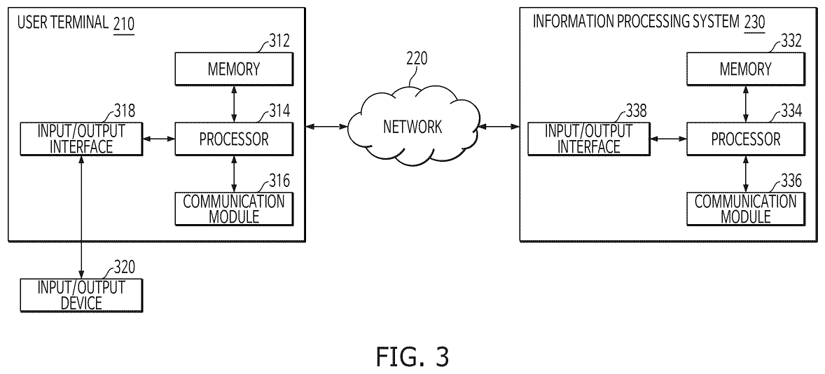

FIG. 3 is a block diagram illustrating internal configurations of a user terminal 210 and the information processing system 230 according to some example embodiments of the present disclosure. The user terminal 210 may refer to any computing device capable of executing an instant messaging application, and the like, and capable of wired and/or wireless communication, and may include, for example, a mobile phone terminal 210_1, a tablet terminal 210_2, a PC terminal 210_3, and the like, of FIG. 2. As illustrated, the user terminal 210 may include a memory 312, a processor 314, a communication module 316, and/or an input/output interface 318. Similarly, the information processing system 230 may include a memory 332, a processor 334, a communication module 336, and/or an input/output interface 338. As illustrated in FIG. 3, the user terminal 210 and the information processing system 230 may be configured to communicate information and/or data through a network 220 using respective communication modules 316 and 336. For example, an input/output device 320 may be configured to input information and/or data into the user terminal 210 through an input/output interface 318 or output information and/or data generated from the user terminal 210. According to some example embodiments, operations described herein as being performed by the user terminal 210, the processor 314, the communication module 316, the input/output interface 318, the processor 334, the communication module 336, and/or the input/output interface 338 may be performed by processing circuitry.

Memories 312 and 332 may include any non-transitory computer-readable storage medium. According to some example embodiments, memories 312 and 332 may include a permanent mass storage device such as ROM (Read Only Memory), a disk drive, a SSD (Solid State Drive), a flash memory, and the like. As another example, a permanent mass storage device such as ROM, SSD, flash memory, a disk drive, and the like may be included in the user terminal 210 or the information processing system 230 as a separate permanent storage device distinct from a memory. For example, an operating system and at least one program code (for example, a code for an application associated with an instant messaging service, a social network service, or an image capturing service during a video call, and the like) may be stored in memories 312 and 332.

These software components may be loaded from a non-transitory computer-readable storage medium separate from memories 312 and 332. Such a separate non-transitory computer-readable storage medium may include a storage medium directly connectable to the user terminal 210 and the information processing system 230, and may include, for example, a non-transitory computer-readable storage medium such as a floppy drive, a disk, a tape, a DVD/CD-ROM drive, a memory card, and the like. As another example, software components may be loaded into memories 312 and 332 through communication modules 316 and 336 rather than a non-transitory computer-readable storage medium. For example, at least one program may be loaded into memories 312 and 332 based on a computer program (for example, an application associated with an instant messaging service, a social network service, or an image capturing service during a video call, and the like) installed by files provided through a network 220 by developers or a file distribution system distributing installation files of an application.

Processors 314 and 334 may be configured to process commands of a computer program by performing basic arithmetic, logic, and input/output operations. A command may be provided to processors 314 and 334 by memories 312 and 332 or communication modules 316 and 336. For example, processors 314 and 334 may be configured to execute a received command according to a program code stored in a recording device such as memories 312 and 332.

Communication modules 316 and 336 may provide a configuration or function for the user terminal 210 and the information processing system 230 to communicate with each other through a network 220, and may provide a configuration or function for the user terminal 210 and/or the information processing system 230 to communicate with another user terminal or another system (for example, a separate cloud system, and the like). For example, a request or data (for example, a multi-party photo capturing request, and the like) generated by the processor 314 of the user terminal 210 according to a program code stored in a recording device such as a memory 312 may be transferred to the information processing system 230 through a network 220 under control of a communication module 316. Conversely, a control signal or a command provided under control of a processor 334 of the information processing system 230 may be received by the user terminal 210 through a communication module 316 of the user terminal 210 via a communication module 336 and a network 220. For example, the user terminal 210 may receive an image (and/or an image sequence) including another user from an information processing system 230.

Input/output interfaces 318 may be means for interfacing with an input/output device 320. According to some example embodiments, the input/output device 320 may include an input device and/or an output device. As an example, the input device may include a device such as a camera including an audio sensor and/or an image sensor, a keyboard, a microphone, a mouse, and the like, and the output device may include a device such as a display, a speaker, a haptic feedback device, and the like. As another example, an input/output interface 318 may be means for interfacing with a device in which configurations or functions for performing input and output are integrated into one, such as a touch screen. Although an input/output device 320 is illustrated as not being included in the user terminal 210 in FIG. 3, it is not limited thereto, and may be configured as one device with the user terminal 210. For example, an input/output interface 338 of the information processing system 230 may be connected to the information processing system 230 or may be means for interfacing with a device (not shown) for input or output that the information processing system 230 may include. Although input/output interfaces 318 and 338 are illustrated as elements configured separately from processors 314 and 334 in FIG. 3, it is not limited thereto, and input/output interfaces 318 and 338 may be configured to be included in processors 314 and 334.

The user terminal 210 and the information processing system 230 may include more components than the components depicted in FIG. 3. However, there is no need to clearly illustrate most of the known technical components. In some example embodiments, the user terminal 210 may be implemented to include at least a part of input/output devices 320 described above. Also, the user terminal 210 may further include other components such as a transceiver, a GPS (Global Positioning System) module (e.g., a GPS receiver), a camera, various sensors, a database, and the like. For example, when the user terminal 210 is a smartphone, the user terminal 210 may include components generally included in a smartphone, and for example, various components such as an acceleration sensor, a gyro sensor, a microphone module, a camera module, various physical buttons, buttons using a touch panel, an input/output port, a vibrator for vibration, and the like, may be implemented to be further included in the user terminal 210.

According to some example embodiments, the processor 314 of the user terminal 210 may be configured such that an instant messaging application or a web browser application providing an instant messaging service including an image capturing service during a video call operates. In such examples, a program code associated with a corresponding application may be loaded into a memory 312 of a user terminal 210. While an application is operated, the processor 314 of the user terminal 210 may receive information and/or data provided from an input/output device 320 through an input/output interface 318 or receive information and/or data from the information processing system 230 through a communication module 316, and may process received information and/or data to store information and/or data in a memory 312. For example, such information and/or data may be provided to the information processing system 230 through a communication module 316.

While an instant messaging application is operated, the processor 314 may receive voice data, text, an image, a video, and the like, input or selected through an input device such as a touch screen connected to an input/output interface 318, a keyboard, a camera including an audio sensor and/or an image sensor, a microphone, and the like, and may store received voice data, text, image, and/or video, and the like in a memory 312 or provide voice data, text, image, and/or video, and the like, to the information processing system 230 through a communication module 316 and a network 220. In some example embodiments, the processor 314 may receive a user input for selecting a graphic object displayed on a display, which is input through an input device, and provide data/request corresponding to a received user input to the information processing system 230 through a network 220 and a communication module 316.

According to some example embodiments, the image sensor may include a plurality of light sensors (e.g., photodiodes) arranged in a grid (e.g., pixels). The plurality of light sensors may each generate a signal (e.g., a current) in response to receiving light (e.g., photons) that collides with one or more among the plurality of light sensors after reflecting off of an object (e.g., a subject of an image). According to some example embodiments, the signal may be proportional to an intensity of the light received by a given light sensor. According to some example embodiments, processing circuitry (e.g., the processor 314) may convert the signals generated by each among the plurality of light sensors into an image based on respective positions of the plurality of lights sensors in the grid. The above-described operations of the camera may be performed continuously to generate a time series of images (e.g., a video).

The processor 314 of the user terminal 210 may output information and/or data by transmitting information and/or data to an input/output device 320 through an input/output interface 318. For example, the processor 314 of the user terminal 210 may output processed information and/or data through an output device such as a display output capable device (e.g., a touch screen, a display, and the like), a voice output capable device (e.g., a speaker), and the like. In some example embodiments, a processor 314 may display a composite image in which images including each of a plurality of users are composited on a display of a user terminal 210.

A processor 334 of the information processing system 230 may be configured to manage, process, and/or store information and/or data received from a plurality of user terminals 210 and/or a plurality of external systems. Information and/or data processed by a processor 334 may be provided to the user terminal 210 through a communication module 336 and a network 220.

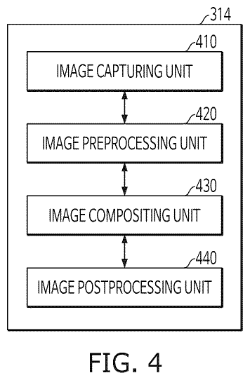

FIG. 4 is a block diagram illustrating an internal configuration of a processor 314 of a user terminal 210 according to some example embodiments of the present disclosure. As illustrated, a processor 314 may include an image capturing unit 410, an image preprocessing unit 420, an image compositing unit 430, an image postprocessing unit 440, and the like. According to some example embodiments, operations described herein as being performed by the image capturing unit 410, the image preprocessing unit 420, the image compositing unit 430, and/or the image postprocessing unit 440 may be performed by processing circuitry.

An image capturing unit 410 may receive an image and/or an image sequence including a user, captured using an image sensor of a user terminal. An image and/or an image sequence may be received/transmitted using a Voice over Internet Protocol (VoIP). The resolution upon transmitting an image and/or an image sequence will be described in detail later with reference to FIG. 5. For example, an image capturing unit 410 may receive an image sequence including a user during a video call or after entering a multi-party photo capturing mode. An image sequence including a user may be transmitted to another user terminal.

In another example, an image capturing unit 410 may receive an image including a user (host) from an image sensor in response to a user (host) selecting a multi-party photo capturing button. For example, an image capturing unit 410 may receive an image including another user (guest) from another user terminal. Thereafter, a composite image may be generated based on an image including a user (host) and an image including another user (guest).

In another example, an image capturing unit 410 may receive an image including a user (guest) captured using an image sensor in response to another user (host) selecting a multi-party photo capturing button. In such examples, an image including a user (guest) may be transferred to another user (host) and used for generating a composite image.

An image preprocessing unit 420 may preprocess (or process) an image captured by an image capturing unit 410 and/or an image received from another user terminal. In some example embodiments, an image preprocessing unit 420 may determine an outline of a user included in a user image captured by an image capturing unit 410, and separate a background image from a user based on a determined outline. Because a composite image is generated based on an image from which background elements are removed through this configuration, an image as if a plurality of users captured photos in one space may be generated. According to some example embodiments, the image preprocessing unit 420 may determine the outline of the user in the user image by performing segmentation on pixels of the images. For example, the image preprocessing unit 420 may classify and/or group each of the pixels in the user image as corresponding to either the user (e.g., the user group of pixels) or the background (e.g., the background group of pixels). The image preprocessing unit 420 may remove (e.g., on a pixel-by-pixel basis) the pixels corresponding to the background from among the pixels of the user image.

In some example embodiments, an image preprocessing unit 420 may normalize color properties (including brightness and saturation, for example) representing hue, color intensity, contrast, shading, and the like, of an image captured by an image capturing unit 410 and/or an image of another user received from another user terminal. Through this configuration, even if a plurality of users capture images in different environments, an image that appears as though the photos were taken in one space may be generated. According to some example embodiments, the color properties (e.g., on a pixel-by-pixel basis) among the pixels of the image and the pixels of the image of the other user with using values of pixels in a reference image (e.g., one of the image captured by the image capturing unit 410 or the image of the other user).

In some example embodiments, an image preprocessing unit 420 may resize an image including each of a plurality of users so that sizes of a plurality of users are similarly displayed in a composite image, or rotate an image so that a plurality of users are displayed in identical or similar directions.

According to some example embodiments, the resolution and/or frame rate of the image sequence may be changed by at least one of downscaling, upscaling, resizing, cropping, frame skipping (or frame dropping), or frame rate conversion. For example, when the available amount of network bandwidth decreases (e.g., falls below a threshold), the user terminal may downscale the image sequence from a current resolution to a lower resolution by reducing the number of pixels in each frame (e.g., from HD 720 to VGA). The downscaling may be performed by the image preprocessing unit 420 of the processor 314 using an interpolation algorithm (e.g., bilinear interpolation or bicubic interpolation). In some example embodiments, when the determined temporary resolution is lower than the minimum (or lowest) resolution, instead of further reducing the resolution, the user terminal may reduce the frame rate (e.g., from 30 frames per second (fps) to 15 fps) by skipping (or dropping) every other frame, thereby reducing the amount of data to be transmitted while maintaining the resolution at or above the minimum (or lowest) resolution.

An image compositing unit 430 may generate a composite image (or a composite image sequence) by compositing images (or an image sequence) including each of a plurality of users. For example, an image compositing unit 430 may generate a composite image by compositing an image including a user (host) and an image including another user (guest). In some example embodiments, an image including another user (guest) may be an image received from a terminal of another user. According to some example embodiments, the image compositing unit 430 may generate a composite image by replacing (or generating) pixels of a first image region with (or by applying) pixels of the image including the user (e.g., on a pixel-by-pixel basis) and replacing (or generating) pixels of a second image region with (or by applying) pixels of the image including the other user (e.g., on a pixel-by-pixel basis), where the first and second image regions may be different regions of the composite image.

An image compositing unit 430 may generate a composite image including a plurality of layers so that an image captured in a user terminal that first entered a multi-party photo capturing mode among a plurality of user terminals is disposed on an upper layer. For example, a host terminal enters a multi-party photo capturing mode together with a multi-party photo capturing request, and thus an image including a host may be disposed on a top layer. In another example, an image compositing unit 430 may change a layout of a layer according to a host's request to change a location of a layer, or arrange a layer according to a layer setting rule preset (or alternatively, given) by a host.

An image postprocessing unit 440 may apply a theme and/or an effect selected by a user to a composite image and/or a photo booth image. In some example embodiments, a configuration of applying a theme and/or an effect selected by a user to a composite image may be performed in an image compositing unit 430. For example, an operation of applying a background or a theme to a composite image may be performed by placing a corresponding background image on a bottom layer. In another example, displaying an effect on a composite image may be performed by placing a corresponding effect image on a top layer. According to some example embodiments, the image postprocessing unit 440 may apply the theme and/or the effect by replacing (e.g., on a pixel-by-pixel basis) a subportion of pixels of the composite image with other graphical data (e.g., a graphical image, etc.). For example, the other graphical data may appear superimposed on the composite image following application by the image postprocessing unit 440.

An internal configuration of a processor 314 illustrated in FIG. 4 is merely an example, and in some example embodiments, components other than an internal configuration shown may be additionally included, and some components may be omitted. For example, when some of the above internal configurations are omitted, a processor 334 of an information processing system and/or another user terminal may be configured to perform functions of some omitted internal configurations. For example, a processor 334 of an information processing system and/or another user terminal may perform an image preprocessing (or processing) operation. For example, although internal configurations of a processor 314 are described by being classified by functions in FIG. 4, it does not necessarily mean that they are physically separated. Although an image capturing unit 410, an image preprocessing unit 420, an image compositing unit 430, and an image postprocessing unit 440 are separately described, this is to help an understanding of the inventive concepts, and is not limited thereto.

FIG. 5 illustrates predetermined (or alternatively, given) minimum (or lowest) resolutions 540, 550, and 560 of an image or an image sequence transmitted and received between users according to some example embodiments of the present disclosure. Because a video call screen 510 (corresponding to 114 in FIG. 1) output after initiating a video call and before entering a multi-party photo capturing mode is output, an image sequence captured by an image sensor of a plurality of user terminals conducting a video call may be output on the video call screen 510. For example, when a video call is initiated among 4 users (e.g., among users included in a chat room) of an instant messaging application, a plurality of image sequences 510_1, 510_2, 510_3, and 510_4 may be output on the video call screen 510 as illustrated in FIG. 5.

One of a plurality of image sequences 510_1, 510_2, 510_3, and 510_4 (for example, a first image sequence 510_1) is an image sequence captured by an image sensor of a user terminal, and the rest of a plurality of image sequences 510_1, 510_2, 510_3, and 510_4 (for example, second to fourth image sequences 510_2, 510_3, and 510_4) may be output on the video call screen 510 by receiving an image sequence captured by an image sensor of another user terminal. Each of a plurality of image sequences 510_1, 510_2, 510_3, and 510_4 may be transmitted and received at a first minimum (or lowest) resolution 540 or higher, and then output on a respective video call screen of a plurality of user terminals.

Because a multi-party photo capturing preview screen 520 (corresponding to 134 in FIG. 1) output after entering a multi-party photo capturing mode and before capturing an image for generating a composite image 530 is output, an image sequence captured by an image sensor of a plurality of user terminals that entered a multi-party photo capturing mode (or a specific sub-group) may be output on the multi-party photo capturing preview screen 520 (also referred to herein as a “preview screen 520”). In some example embodiments, a multi-party photo capturing preview screen 520 may have a higher video quality than the video call screen 510. For example, a resolution, a bitrate, a frame rate, and/or a color depth of a preview screen 520 may be higher than those of the video call screen 510.

When 2 users among the 4 users displayed on the video call screen 510 enter a photo capturing mode, 2 image sequences 520_1 and 520_2 may be output on a preview screen 520 as illustrated in FIG. 5. An image sequence displayed on a preview screen 520 illustrated in FIG. 5 may be a composite image sequence in which 2 image sequences 520_1 and 520_2 are composited.

One of a plurality of image sequences 520_1 and 520_2 (for example, a sixth image sequence 520_2) is an image sequence captured by an image sensor of a user terminal, and the remaining of a plurality of image sequences 520_1 and 520_2 (for example, a fifth image sequence 520_1) may be an image sequence received from another user terminal. Each of a plurality of image sequences 510_1 and 510_2 may be transmitted and received at a second minimum (or lowest) resolution 550 or higher, and then output on a respective video call screen of a plurality of user terminals.

In some example embodiments, a resolution of each image sequence transmitted may be determined based on a network bandwidth and a minimum (or lowest) resolution associated with a plurality of user terminals. For example, when a network bandwidth associated with a user terminal participating in a video call or a multi-party photo capturing mode is relatively low, an image sequence is transmitted at a first minimum (or lowest) resolution 540 (e.g., when participating in a video call before entering a multi-party photo capturing mode) or at a second minimum (or lowest) resolution 550 (e.g., when in the multi-party photo capturing mode), and when a network bandwidth is higher, an image sequence may be transmitted at a resolution higher than a first minimum (or lowest) resolution 540 (e.g., when participating in a video call before entering a multi-party photo capturing mode) or higher than a second minimum (or lowest) resolution 550 (e.g., when in the multi-party photo capturing mode) within a range allowed by a network bandwidth.

In some example embodiments, a first minimum (or lowest) resolution 540 may be lower than a second minimum (or lowest) resolution 550. If the number of users entering a multi-party photo capturing mode is smaller than the number of users conducting a video call, an image/image sequence of a higher resolution may be provided in a multi-party photo capturing mode when the same bandwidth (or a similar bandwidth) is used. Through this, the bandwidth associated with a plurality of user terminals may be used more efficiently.

In some example embodiments, a frame rate of the fifth and/or sixth image sequences 520_1 and 520_2 may be lower than a frame rate of the first to fourth image sequences 510_1, 510_2, 510_3, and 510_4. For example, a temporary resolution associated with the fifth and/or sixth image sequences 520_1 and 520_2 may be determined based on the network bandwidth associated with a plurality of user terminals. If the determined temporary resolution is lower than a predetermined (or alternatively, given) second minimum (or lowest) resolution 550, instead of determining a resolution associated with fifth and sixth image sequences 520_1 and 520_2 as a resolution (for example, a second minimum (or lowest) resolution 550) greater than or equal to a second minimum (or lowest) resolution, a frame rate for the transmission and reception of the fifth and sixth image sequences 520_1 and 520_2 may be lowered. Through this, it may be ensured (or a likelihood improved) that the fifth and sixth image sequences 520_1 and 520_2 are transmitted and received at a resolution greater than or equal to the second minimum (or lowest) resolution 550 even if the bandwidth is insufficient.

According to some example embodiments, the user terminal (e.g., the first user terminal, the second user terminal, or any of the user terminals 210_1, 210_2, and 210_3) may determine an available amount of network bandwidth by monitoring a throughput of a network interface (e.g., the communication module 316) of the user terminal. For example, the user terminal may measure a data rate at which data packets are successfully transmitted and/or received through the network interface over a measurement period (e.g., a sliding window of a few seconds). Alternatively or additionally, the user terminal may receive bandwidth information from the information processing system 230 (e.g., a server), which may aggregate network condition reports from a plurality of user terminals participating in the video call. In some example embodiments, the user terminal may estimate the available amount of network bandwidth based on at least one of a round-trip time (RTT) of packets transmitted between the user terminal and another user terminal (or the information processing system 230), a packet loss rate, a jitter value, or a signal strength indicator (e.g., Received Signal Strength Indication (RSSI)) of a wireless connection.

According to some example embodiments, the user terminal may determine the resolution of the image sequence to be transmitted based on the determined available amount of network bandwidth. For example, the user terminal may use a mapping table (or a lookup table) that maps ranges of available bandwidth values to corresponding resolution values. The mapping table may define, for a video call mode, that an available bandwidth below a first threshold (e.g., 500 kbps) corresponds to the first minimum (or lowest) resolution (e.g., QVGA, 320×240 pixels), an available bandwidth between the first threshold and a second threshold (e.g., 1.5 Mbps) corresponds to a resolution of VGA (640×480 pixels), and an available bandwidth above the second threshold corresponds to a resolution of HD 720 (1280×720 pixels). In the multi-party photo capturing mode, the mapping table may define different (e.g., higher) resolution values for the same bandwidth ranges, because fewer user terminals participate in the multi-party photo capturing mode than in the video call and thus more bandwidth is available per user terminal.

After a multi-party photo capturing preview screen 520 is output, a composite image 530 may be generated in response to an image capturing request of a host. A composite image 530 may be generated using a first image 530_1 and a second image 530_2, and one of a plurality of images 530_1 and 530_2 may be an image captured by an image sensor of a host terminal, and the rest of a plurality of images 530_1 and 530_2 may be an image received from a guest terminal. An image captured by an image sensor of a guest terminal may be transmitted to a host terminal at a resolution (or a predetermined or alternatively, given resolution) greater than or equal to a third minimum (or lowest) resolution 560.

In some example embodiments, a third minimum (or lowest) resolution 560 may be higher than a second minimum (or lowest) resolution. Through this, a higher-resolution composite image 530 may be generated.

In some example embodiments, a resolution of a composite image 530 may be higher than a first minimum (or lowest) resolution 540 which is a resolution during a video call. Additionally, a resolution of a composite image 530 may be higher than a third minimum (or lowest) resolution 560 which is a resolution of each of received images 530_1 and 530_2.

A resolution of an image and/or an image sequence transmitted and received may be different from a resolution when an identical (or similar) image and/or image sequence is displayed on a display of a user terminal. For example, an image and/or an image sequence received by a user terminal may be output on a display after processing such as upscaling, downscaling, resizing, cropping, or padding is performed according to a ratio and/or size of a display of a user terminal, a user custom setting, performance of a user terminal, and the like. According to some example embodiments, each among the first minimum (or lowest) resolution 540, the second minimum (or lowest) resolution and/or the third minimum (or lowest) resolution 560 may be a design parameter determined through empirical study.

Although a plurality of minimum (or lowest) resolutions 540, 550, and 560 are illustrated with an identical (or similar) aspect ratio in FIG. 5, it is not limited thereto. In cases where the resolutions do not have the same aspect ratio (or similar aspect ratios), the levels of the resolutions may be compared using the total number of pixels, PPI (Pixels Per Inch), and the like.

FIG. 6 illustrates an operation of entering a multi-party photo capturing mode at a host terminal side according to some example embodiments of the present disclosure. A first operation 610 illustrates an example in which an area 612 capable of selecting attributes of a photo booth image to be captured and a button 614 for entering a multi-party photo capturing mode are displayed on a display of a host terminal by a user selecting a multi-party photo capturing mode entry button in a host terminal during a video call. Although it is illustrated in FIG. 6 that the number of composite images to be included in a photo booth image is selected in an area 612, it is not limited thereto. For example, a host may set positions, sizes, themes, and the like, of each composite image in advance in an area 612.

A second operation 620 illustrates an example in which a multi-party photo capturing mode is entered in response to receiving a user input selecting a button 614 in a host terminal. As illustrated, a first image sequence captured by an image sensor of a host terminal may be displayed on the first area 622 of the display. For example, a second image sequence received from a guest terminal may be displayed on a second area 624 of a display. Here, a guest terminal may be a user terminal of another user who entered a multi-party photo capturing mode generated by a host while conducting a video call with a host. For example, a host may adjust positions, sizes, and the like, of areas where a first image sequence and a second image sequence are to be displayed in a multi-party photo capturing mode.

In some example embodiments, a host may set and/or change the number of images to be included in a composite image in an area 630. For example, a host may select a number ‘2’ in an area 630 to set consecutive capturing of 2 composite images. In some example embodiments, a host may select a number ‘4’ in an area 630 to set consecutive capturing of 4 composite images. Although it is illustrated that a host may select one of 1 to 4 images in an area 630, it is not limited thereto, and a host may select an arbitrary (or different) number.

In some example embodiments, as a host selects a multi-party photo capturing button 626, a capturing preparation notification may be displayed. Thereafter, a multi-party photo capturing may be executed while a capturing notification is displayed, thereby generating a composite image (or a photo booth image). A composite image may be generated in a host terminal using a first image captured using an image sensor of a host terminal and a second image received by a host terminal from a guest terminal. A generated composite image may be displayed on a display of a host terminal and a guest terminal for confirmation by a host and a guest.

In some example embodiments, as a host selects a multi-party photo capturing button 626, video capturing starts, and a composite video (or a photo booth video) may be generated. Here, a composite video (or a photo booth video) may include a plurality of composite images (or a plurality of photo booth images). The composite video may be captured for a predetermined (or alternatively, given) time or captured for a time according to a user input (for example, a time during which a user keeps pressing a multi-party photo capturing button 626). A generated composite video (or a photo booth video) may be stored or reproduced at a predetermined (or alternatively, given) multiple speed (for example, double speed or triple speed).

In some example embodiments, a host may select an exit button 628 before or after capturing of a photo booth image is completed. Because a host selects an exit button 628 before capturing of a photo booth image is completed, a multi-party photo capturing mode may be terminated in a host terminal. In this case, host authority may be granted to one user among guests included in a multi-party photo capturing mode (for example, a guest who entered a multi-party photo capturing mode in an order next to a host). Delegation of host authority may be performed according to a lapse of a predetermined (or alternatively, given) time (for example, 5 seconds) after a multi-party photo capturing mode is terminated in a host terminal, and host authority may be maintained when a host accesses a multi-party photo capturing mode again before a predetermined (or alternatively, given) time elapses.

Conversely, when a host selects an exit button 628 after capturing of a photo booth image is completed, the photo booth image may be stored in a host terminal and/or transmitted to a guest terminal through a chat room where a video call was made or a 1:1 chat room with a guest, or may be transferred to a guest terminal in a form of metadata of a Voice over Internet Protocol (VoIP) call packet including data corresponding to a photo booth image. According to some example embodiments, the metadata including the data corresponding to the photo booth image may be transferred to the guest terminal via the video call in which the guest terminal participates along with the host terminal.

FIG. 7 illustrates an operation of entering a multi-party photo capturing mode at a guest terminal side according to some example embodiments of the present disclosure. A first operation 710 illustrates an example in which an area 712 for determining whether to accept a request is displayed on a display of a guest terminal as a guest terminal receives a multi-party photo capturing request from a host terminal during a video call.

In some example embodiments, attribute information, and the like, of a photo booth image to be captured may be displayed in an area 712. For example, although it is illustrated in FIG. 7 that information associated with a theme of a photo booth image is displayed, it is not limited thereto, and the number, positions, sizes, and the like, of composite images may be displayed. For example, information such as a host of a multi-party photo capturing mode and a list of participating guests may be further displayed. A guest may enter a multi-party photo capturing mode by selecting a first button 714 in an area 712 or reject multi-party photo capturing by selecting a second button 716.

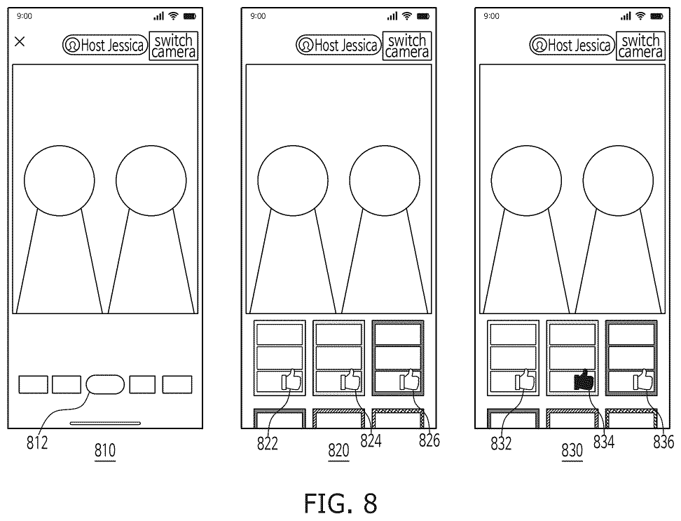

A second operation 720 illustrates an example in which a multi-party photo capturing mode is entered by a user selecting a first button 714 in a guest terminal. Unlike in FIG. 6, a third button 726 for checking a theme currently applied to a photo booth image and/or applicable theme information may be displayed on a display of a guest terminal instead of a multi-party photo capturing button. After selecting a third button 726, a guest may select theme information desired to be applied to a photo booth image. This will be described later in detail with reference to FIG. 8.

As illustrated, a first image sequence received from a host terminal may be displayed on a first area 722 of a display. Additionally, a second image sequence captured by an image sensor of a guest terminal may be displayed on a second area 724 of a display.

In some example embodiments, a guest may exit a multi-party photo capturing mode by selecting an exit button 728 before or after capturing of a photo booth image is completed. In this case, a multi-party photo capturing mode is terminated in the guest terminal, and a video call screen before entering a multi-party photo capturing mode may be displayed.

FIG. 8 illustrates an example in which a guest gives feedback to a photo theme according to some example embodiments of the present disclosure. A first operation 810 illustrates an example of a screen displayed on a display of a guest terminal as the guest terminal enters a multi-party photo capturing mode.

A second operation 820 illustrates an example in which a plurality of photo themes applicable to a photo booth image/composite image are displayed by a guest selecting a button 812 after a guest terminal enters a multi-party photo capturing mode and before displaying a capturing notification. Thereafter, a guest may give feedback (for example, positive feedback or negative feedback, and the like) to a specific photo theme by selecting at least one of visual objects 822, 824, and 826 displayed on previews (e.g., thumbnails) of a plurality of photo themes.

A third operation 830 illustrates an example in which a visual object 834 representing feedback is displayed together near a selected photo theme in response to the guest giving feedback (or positive feedback) to a specific photo theme by selecting the visual object 824. Because the visual object 834 displayed on a selected photo theme as the guest gives feedback to a specific photo theme is different from other visual objects 832 and 836 to which feedback is not given, a guest may easily check a photo theme to which feedback is given.

Additionally, a host may check the number of feedbacks (may also be described herein as indications of feedback, feedback indications, feedback inputs, etc.) given to a photo theme by guest(s) through a host terminal. Through this configuration, the host may reflect the guests' opinions when selecting a photo theme to be applied to a photo booth image/composite image. Alternatively, a photo theme having the largest number of positive feedbacks (e.g., indications of feedback, feedback indications, feedback inputs, etc.) may be automatically applied to a photo booth image/composite image, or a message suggesting changing to a photo theme having the largest number of positive feedbacks (e.g., indications of feedback, feedback indications, feedback inputs, etc.) may be provided to a host.

After a host selects a photo theme to be applied to a photo booth image/composite image, a first image sequence captured by an image sensor of a host terminal may be displayed in a first area of a selected photo theme on a display. In addition, a second image sequence captured by an image sensor of a guest terminal may be displayed in a second area of the selected photo theme on a display.

In some example embodiments, a photo theme may include a pose guide. Here, a pose guide may be a visual guide displayed on a display so that users may easily follow a specific pose. For example, a first pose guide may be overlaid and displayed on a first image sequence in a first area of a selected photo theme, and a second pose guide may be overlaid and displayed on a second image sequence in a second area. Because users are induced to capture photos in various poses through this configuration, users may capture a composite image having a higher-quality composition without a need to conceive a pose.

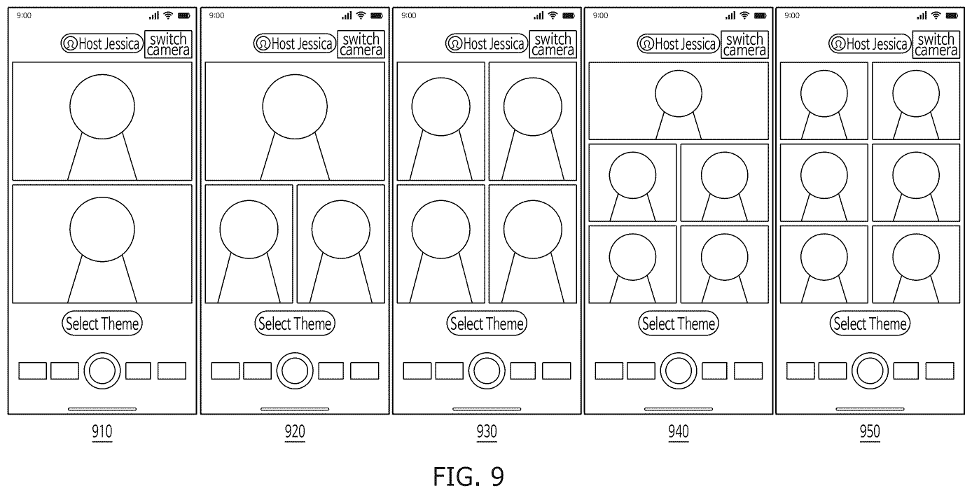

FIG. 9 illustrates an example in which a photo booth image is displayed according to some example embodiments of the present disclosure. In first to fifth examples 910, 920, 930, 940, and 950 of FIG. 9, a plurality of users included in each grid of a photo booth image may correspond to a user who entered a multi-party photo capturing mode. Although it is illustrated that one user is included in each grid in FIG. 9, it is not limited thereto. First to fifth examples 910, 920, 930, 940, and 950 are examples of cases where 2 to 6 users respectively enter a multi-party photo capturing mode (e.g., sequentially enter the multi-party photo capturing mode).

A photo booth image may be generated by combining images including each of a plurality of users, and relative positions and sizes of grids may be changed whenever a user entering a multi-party photo capturing mode is added or removed. For example, it may be confirmed that an upper grid in a photo booth image of a second example 920 is moved to the left from an existing position after a user is added in a third example 930, and at the same time (or contemporaneously), a size (of the images in the upper grid) is reduced by half. Positions of a grid or a user in a photo booth image may be determined based on a predetermined (or alternatively, given) layout rule and the number of users who entered a multi-party photo capturing mode, or may be changed based on a user input of a host changing positions of a grid or each user.

In some example embodiments, a photo booth image/composite image includes a plurality of layers, and an image/image sequence of a user who first entered a multi-party photo capturing mode may be disposed on an upper layer. In such examples, a composite image may be generated by compositing images including each of a plurality of users, and relative position or size (layout) of a user in a composite image may be changed whenever a user entering a multi-party photo capturing mode is added or removed.

A position or size of a user in a composite image may be determined based on a predetermined (or alternatively, given) user layout rule and the number of users who entered a multi-party photo capturing mode, or may be changed based on a user input of a host changing a position or size of each user.

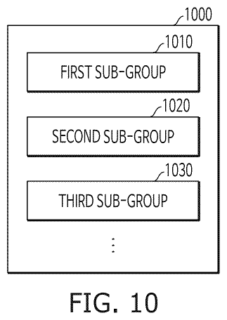

FIG. 10 illustrates a video call group 1000 associated with a video call and sub-groups 1010, 1020, and 1030 associated with a multi-party photo capturing mode according to some example embodiments of the present disclosure. When a video call is initiated in a chat room of an instant messaging application, a user participating in a video call may enter a video call group 1000. Some or all of users in a chat room may enter a video call group 1000, and an image sequence may be transmitted and received among users in a video call group 1000.

Thereafter, when a user enters a multi-party photo capturing mode during a video call, a user may enter one of sub-groups 1010, 1020, and 1030 associated with multi-party photo capturing in a video call group 1000. That is, while one video call is in progress, a plurality of sub-groups 1010, 1020, and 1030 for generating a composite image may be generated, and composite images including a user who entered each of sub-groups 1010, 1020, and 1030 may be generated.

The maximum (or highest) number of users who may participate (or associated with participation) in each sub-group 1010, 1020, and 1030 (or multi-party photo capturing) may be less than the maximum (or highest) number of users who may participate (or associated with participation) in a video call group 1000 (or a video call). In some example embodiments, the maximum (or highest) number of users who may participate in each sub-group may be set to a predetermined (or alternatively, given) number of people (for example, 4 people). According to some example embodiments, each among maximum (or highest) number of users who may participate (or associated with participation) in each sub-group and/or the maximum (or highest) number of users who may participate (or associated with participation) in a video call group 1000 (or a video call) may be a design parameter determined through empirical study.

In some example embodiments, a user may select whether to enter one or more among the sub-groups 1010, 1020, and 1030. For example, a user may receive a multi-party photo capturing request from a host terminal that generated a specific sub-group, and enter a corresponding sub-group by accepting a request.

In some example embodiments, a user may select a sub-group to enter among a plurality of sub-groups 1010, 1020, and 1030. For example, while a multi-party photo capturing mode is in progress in each of a plurality of sub-groups 1010, 1020, and 1030 during a video call, a user may select which sub-group to enter among a plurality of sub-groups 1010, 1020, and 1030. That is, a user may enter by selecting one of sub-groups in which another user is already participating, instead of acting as a host role by newly generating a sub-group. For example, information associated with a sub-group in which another user is participating (such as a time during which a multi-party photo capturing mode in a sub-group is in progress, information of participating personnel, and the like) is output to a user terminal, and a user may check information associated with a sub-group and then select one of sub-groups.

When a user attempts to enter a specific sub-group, but users participating in a corresponding sub-group exceed a predetermined (or alternatively, given) number of people (for example, 4 people), a user may enter a photo capturing viewing mode instead of a photo capturing mode. That is, a user who entered a photo capturing viewing mode may view a multi-party photo capturing process of other users, but may not participate in multi-party photo capturing himself/herself.

In some example embodiments, when users (e.g., a number of users) participating in a specific sub-group are equal to or less than a predetermined (or alternatively, given) number of people (also referred to herein as a first number of people), a newly entered user may enter a multi-party photo capturing mode. In this case, a first image sequence captured by an image sensor of an already participating user terminal may be displayed on a first area of a display, and a second image sequence received from a newly entered user terminal may be displayed on a second area of a display. Although FIG. 10 illustrates three sub-groups 1010, 1020 and 1030 within the video call group 1000, this is merely an example and some example embodiments are not limited thereto. According to some example embodiments, the number of sub-groups within the video call group 1000 may be greater than three or less than three. According to some example embodiments, the predetermined (or alternatively, given) number of people may be a design parameter determined through empirical study.

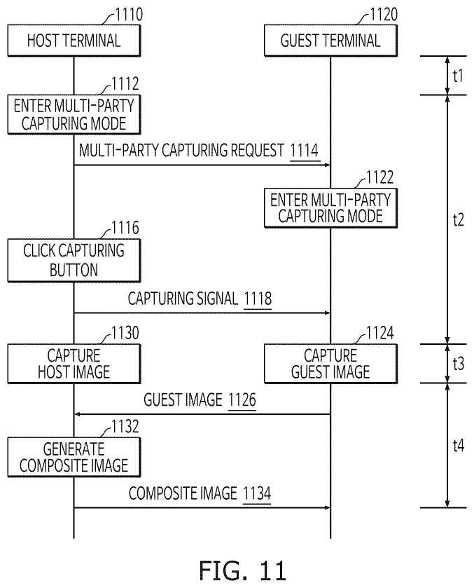

FIG. 11 is a flowchart illustrating a process for generating a composite image according to some example embodiments of the present disclosure. After a video call is initiated between a host terminal 1110 associated with a first user and a guest terminal 1120 associated with a second user included in a chat room of an instant messaging application, the host terminal 1110 may enter a multi-party photo capturing mode in an operation 1112. For example, a host terminal may enter a multi-party photo capturing mode by (e.g., in response to) receiving a user input selecting a multi-party photo capturing mode entry button through a touch input, or the like.

From a first time point after a video call is initiated until a second time point of entering the multi-party photo capturing mode (in operation 1112), the host terminal 1110 and the guest terminal 1120 may conduct a video call by transmitting an image sequence captured by an image sensor of each terminal to the other terminal at a first resolution. That is, an image sequence may be transmitted and received between terminals at a first resolution during a first time period t1 (e.g., from the first time point to the second time point). Here, a first resolution may be greater than or equal to a first minimum (or lowest) resolution, and the host terminal 1110 and the guest terminal 1120 may transmit an image sequence to a counterpart terminal at different resolutions according to network conditions.

When the host terminal 1110 enters a multi-party photo capturing mode (in operation 1112), the host terminal 1110 may transmit a multi-party photo capturing request in operation 1114 to the guest terminal 1120. Thereafter, when (e.g., in response to) receiving a user input agreeing to a multi-party photo capturing request, the guest terminal 1120 may enter a multi-party photo capturing mode in operation 1122.

Thereafter, the host terminal 1110 may receive a user input clicking a capturing button from a user in operation 1116. As the host terminal 1110 receives (e.g., in response to receiving) a user input clicking a capturing button, the host terminal 1110 may transmit a capturing signal to the guest terminal 1120 in operation 1118.

In response to receiving a user input clicking a capturing button by the host terminal 1110, the host terminal 1110 may capture an image including a host by using an image sensor in operation 1130. Similarly, upon (e.g., in response to) receiving a capturing signal from the host terminal 1110, the guest terminal 1120 may capture an image including a guest by using an image sensor in operation 1124.

From the second time point of entering a multi-party photo capturing mode in operation 1112 to a third time point before image capturing in operations 1124 and 1130, the host terminal 1110 and the guest terminal 1120 transmit an image sequence captured by an image sensor of each terminal to the other terminal at a second minimum (or lowest) resolution or higher, so that a preview screen before generating a composite image may be output. That is, an image sequence may be transmitted and received between terminals at a second minimum (or lowest) resolution or higher during a second time period t2 (e.g., from the second time point to the third time point) when a multi-party photo capturing mode is entered (e.g., in response to the multi-party photo capturing mode being entered).

Thereafter, the host terminal 1110 may receive an image including a guest from the guest terminal 1120 in operation 1126. Tn image including the guest may be transmitted to the host terminal 1110 at a third resolution. That is, after an image is captured at the third resolution during a third time period t3, it may be transmitted and received. In some example embodiments, an image including a host captured by a host terminal 1110 may also be transmitted to a guest terminal 1120 at a third resolution (or higher than or equal to a third resolution).

Even after an image is captured, the multi-party photo capturing mode is maintained, and an image sequence may be transmitted and received between terminals at a second minimum (or lowest) resolution or higher. That is, even during the fourth time period t4 following image capturing, the image sequence may be transmitted and received between terminals at a second minimum (or lowest) resolution or higher, similar to the second time period t2. Conversely, after the multi-party photo capturing mode is terminated, the image sequence is transmitted and received between terminals at a first minimum (or lowest) resolution or higher, and a video call may proceed.

In some example embodiments, each of a first minimum (or lowest) resolution, a second minimum (or lowest) resolution, and a third resolution may be different from each other. For example, a resolution may increase in order of the first minimum (or lowest) resolution, the second minimum (or lowest) resolution, and the third resolution (or a third minimum (or lowest) resolution).

Thereafter, the host terminal 1110 may generate a composite image by compositing the image including the host and the image including the guest in operation 1132. A resolution of the composite image may be higher than the first minimum (or lowest) resolution. For example, the resolution of the composite image may be higher than or equal to the third resolution.

Thereafter, the generated composite image may be transmitted to the guest terminal 1120 in operation 1134. In some example embodiments, the composite image may be transferred to a guest terminal 1120 through a chat room including the host and the guest (for example, a group chat room or a 1:1 chat room). Additionally or alternatively, the composite image may be transmitted to the guest terminal 1120 using Voice over Internet Protocol (VoIP). For example, after metadata of a Voice over Internet Protocol (VoIP) call packet including data corresponding to the composite image is generated, the generated metadata may be transmitted to the guest terminal 1120. The generated metadata may be metadata in a protocol of a VoIP call channel connected to the host and the guest. Operations described herein as being performed by the host terminal 1110 and/or the guest terminal 1120 may be performed by processing circuitry.

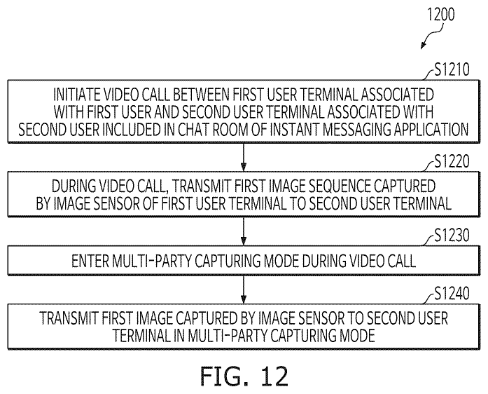

FIG. 12 is a flowchart illustrating a method 1200 of capturing an image during a video call according to some example embodiments of the present disclosure. Method 1200 may be performed by processing circuitry (e.g., at least one processor) of a first user terminal. The processing circuitry may initiate a video call between the first user terminal associated with a first user and a second user terminal associated with a second user included in a chat room of an instant messaging application (S1210).

During the video call, the processing circuitry may transmit a first image sequence captured by an image sensor of the first user terminal to the second user terminal (S1220). The first image sequence may be transmitted at a first resolution.

During the video call, the processing circuitry may enter a multi-party photo capturing mode (S1230). For example, the processing circuitry may enter a specific sub-group among a plurality of sub-groups associated with multi-party photo capturing. In such examples, the second user may be a user included in an identical (or similar) specific sub-group as a first user.

In some example embodiments, the maximum (or highest) number of users who may participate in multi-party photo capturing may be less than the maximum (or highest) number of users who may participate in the video call.

In some example embodiments, in response to determining that users participating in the multi-party photo capturing mode are equal to or less than a predetermined (or alternatively, given) number of people after entering the multi-party photo capturing mode, the processing circuitry may display a first image sequence on a first area of a display of a user terminal, and display a second image sequence received from the second user terminal on a second area of the display.

In some example embodiments, after entering the multi-party photo capturing mode and before capturing a first image, the processing circuitry may transmit a second image sequence captured by an image sensor to the second user terminal. A second image sequence is transmitted to the second user terminal at a third resolution, and the third resolution may be different from the first resolution and the second resolution at which the first image captured by the image sensor is transmitted. For example, the third resolution may be higher than the first resolution and lower than the second resolution.

In some example embodiments, the processing circuitry may determine a temporary resolution associated with a second image sequence based on a network bandwidth associated with the first user terminal and, in response to determining that the temporary resolution is lower than a predetermined (or alternatively, given) minimum (or lowest) resolution, increase the resolution of the second image sequence from the temporary resolution to the third resolution and decrease the frame rate of the second image sequence.

In some example embodiments, the first resolution may be less than or equal to a third minimum (or lowest) resolution, and the third resolution may be less than or equal to a second minimum (or lowest) resolution.

In the multi-party photo capturing mode, the processing circuitry may transmit the first image captured by the image sensor to the second user terminal (S1240). The first image may be transmitted at the second resolution different from the first resolution at which the first image sequence is transmitted, and the second resolution may be higher than the first resolution.

In some example embodiments, the first resolution may be greater than or equal to a predetermined (or alternatively, given) first minimum (or lowest) resolution, the second resolution may be greater than or equal to a predetermined (or alternatively, given) second minimum (or lowest) resolution, and the second minimum (or lowest) resolution may be higher than the first minimum (or lowest) resolution.

In some example embodiments, after the video call is initiated and before the multi-party photo capturing mode is entered, the processing circuitry may output a video call screen on a display of the first user terminal, and after the multi-party photo capturing mode is entered and before the first image is captured, the processing circuitry may output a multi-party photo capturing preview screen on the display. The multi-party photo capturing preview screen may have a higher video quality than the video call screen.

In some example embodiments, the first image sequence captured by the image sensor of the first user terminal during the video call is transmitted at a first resolution, and the second image sequence captured by the image sensor after entering the multi-party photo capturing mode may be transmitted at a third resolution. The first resolution and the third resolution may be determined based on a network bandwidth associated with the first user terminal. For example, the third resolution may be higher than the first resolution. For example, a frame rate of the second image sequence transmitted at the third resolution may be lower than a frame rate of the first image sequence transmitted at the first resolution.

In some example embodiments, after entering the multi-party photo capturing mode, the processing circuitry may receive a user input selecting a multi-party photo capturing button from the first user, capture the first image including the first user using the image sensor, receive the second image including the second user from the second user terminal, and generate a composite image by compositing the first image and the second image. A resolution of the composite image may be higher than the first resolution.

In some example embodiments, the processing circuitry may transmit the composite image to the second user terminal through a chat room including the first user and the second user (e.g., a chat room in which both the first user and the second user are members and/or participate). In some example embodiments, processing circuitry may generate metadata of a Voice over Internet Protocol (VoIP) call packet including data corresponding to the composite image, and transmit the metadata to the second user participating in the video call. The metadata may be metadata in a protocol of a VoIP call channel connected to the first user and the second user participating in the video call.

Thereafter, the processing circuitry may output the composite image in which the first image including the first user and the second image including the second user are composited on the display of the first user terminal.

Flowcharts and above-described descriptions illustrated in FIG. 11 and FIG. 12 are only an example, and may be implemented differently in some example embodiments. For example, an order of some operations may be changed, some operations may be omitted, or other configurations (e.g., operations) may be added, and some operations described as being sequentially (or separately) performed may be performed simultaneously (or contemporaneously).

The above-described method may be provided as a computer program stored in a non-transitory computer-readable storage medium for execution in a computer. A non-transitory computer-readable storage medium may continuously store an executable program in a computer, or temporarily store an executable program for execution or downloading. For example, a non-transitory computer-readable storage medium may be various recording means or storage means in a form in which single or several hardware devices are combined, and is not limited to a non-transitory computer-readable storage medium directly connected to a certain computer system, and may be distributed and exist on a network. Examples of a non-transitory computer-readable storage medium may include magnetic media such as a hard disk, a floppy disk, and a magnetic tape, optical recording media such as CD-ROM and DVD, magneto-optical media such as a floptical disk, and those configured to store program instructions including ROM, RAM, flash memory, and the like. For example, examples of other non-transitory computer-readable storage media include a recording medium or a storage medium managed by an app store that distributes an application, a site that supplies or distributes various other software, a server, and the like.

Methods, operations, or techniques of the present disclosure may be implemented by various means. For example, such techniques may be implemented in hardware, firmware, software, or a combination thereof. An ordinary skilled person will understand that various example logical blocks, modules, circuits, and algorithm operations described in connection with the disclosure herein may be implemented in electronic hardware, computer software, or combinations of both. To clearly illustrate such interchangeability of hardware and software, various example components, blocks, modules, circuits, and operations have been generally described above in terms of their functionality. Whether such functionality is implemented as hardware or a combination of hardware and software depends upon particular application and design constraints imposed on an overall system. An ordinary skilled person may implement described functionality in varying ways for each particular application, but such implementations should not be interpreted as causing a departure from the scope of the present disclosure.

In a hardware implementation, processing units used to perform techniques may be implemented within one or more ASICs, DSPs, Digital Signal Processing Devices (DSPDs), Programmable Logic Devices (PLDs), Field Programmable Gate Arrays (FPGAs), processors, controllers, microcontrollers, microprocessors, electronic devices, other electronic units designed to perform functions described in the present disclosure, a computer, or combinations thereof.

Accordingly, various example logical blocks, modules, and circuits described in connection with the present disclosure may be implemented or performed with a general-purpose processor, DSP, ASIC, FPGA or other programmable logic device, discrete gate or transistor logic, discrete hardware components, or any combination of those designed to perform functions described herein. A general-purpose processor may be a microprocessor, but in some example embodiments, a processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other combination of configurations.

In a firmware and/or software implementation, techniques may be implemented as instructions stored on a non-transitory computer-readable medium such as Random Access Memory (RAM), Read-Only Memory (ROM), Non-Volatile Random Access Memory (NVRAM), Programmable Read-Only Memory (PROM), Erasable Programmable Read-Only Memory (EPROM), Electrically Erasable PROM (EEPROM), a flash memory, a Compact Disc (CD), a magnetic or optical data storage device, and the like. Instructions may be executable by one or more processors, and may cause processor(s) to perform specific aspects of functionality described in the present disclosure.

Although some example embodiments have been described as utilizing aspects of a currently disclosed subject matter in one or more standalone computer systems, the present disclosure is not limited thereto, and may be implemented in connection with any computing environment such as a network or distributed computing environment. For example, aspects of a subject matter in the present disclosure may be implemented in a plurality of processing chips or devices, and storage may be similarly affected across a plurality of devices. Such devices may include PCs, network servers, and portable devices.

According to some example embodiments, improved devices and methods are provided. For example, the improved devices and methods may involve providing a “photo booth” type service during a video call by providing images during the “photo booth” types service that are of a different resolution (e.g., a higher resolution) than images provided during the video call service. Also, according to some example embodiments, in the event that a current bandwidth of a user terminal is insufficient to provide for a higher image resolution during the “photo booth” type service at the image frame rate provided during the video call service, the image frame rate may be reduced to make available sufficient bandwidth for the higher image resolution. Accordingly, the improved devices and methods overcome the deficiencies of the existing devices and methods to at least enable a “photo booth” type service of sufficiently quality (e.g., at a sufficient image resolution) during a video call.

Although the present disclosure has been described with reference to some example embodiments in the present specification, various modifications and changes may be made without departing from the scope of the present disclosure that may be understood by an ordinary skilled person in the art to which the present disclosure pertains. For example, such modifications and changes should be considered to fall within the scope of the appended claims.

What is claimed is:

1. A method performed by at least one processor of a first user terminal, the method comprising:
initiating a video call between the first user terminal and a second user terminal, the first user terminal being associated with a first user, the second user terminal being associated with a second user, and the first user and the second user being included in a chat room of an instant messaging application;
transmitting a first image sequence captured by an image sensor of the first user terminal to the second user terminal during the video call, the first image sequence being transmitted at a first resolution;
entering a multi-party photo capturing mode during the video call; and
transmitting a first image captured by the image sensor to the second user terminal in the multi-party photo capturing mode, the first image being transmitted at a second resolution different from the first resolution.

2. The method as claimed in claim 1, further comprising:
outputting a composite image on a display of the first user terminal, the first image and a second image being composited in the composite image, the first image including the first user, and the second image including the second user.

3. The method as claimed in claim 1, wherein the second resolution is higher than the first resolution.

4. The method as claimed in claim 1, wherein
the first resolution is greater than or equal to a first minimum resolution;
the second resolution is greater than or equal to a second minimum resolution; and
the second minimum resolution is higher than the first minimum resolution.

5. The method as claimed in claim 1, further comprising:
transmitting a second image sequence captured by the image sensor to the second user terminal after the entering the multi-party photo capturing mode and before capturing the first image, the second image sequence being transmitted to the second user terminal at a third resolution, and the third resolution being different from both the first resolution and the second resolution.

6. The method as claimed in claim 5, wherein the third resolution is higher than the first resolution and lower than the second resolution.

7. The method as claimed in claim 5, wherein
the first resolution is greater than or equal to a first minimum resolution;
the second resolution is greater than or equal to a second minimum resolution;
the third resolution is greater than or equal to a third minimum resolution;
the third minimum resolution is higher than the first minimum resolution; and
the second minimum resolution is higher than the third minimum resolution.

8. The method as claimed in claim 7, wherein
the first resolution is less than or equal to the third minimum resolution; and
the third resolution is less than or equal to the second minimum resolution.

9. The method as claimed in claim 1, further comprising:
outputting a video call screen on a display of the first user terminal after the initiating the video call and before the entering the multi-party photo capturing mode; and
outputting a multi-party photo capturing preview screen on the display after the entering the multi-party photo capturing mode and before capturing the first image, the multi-party photo capturing preview screen has a higher video quality than the video call screen.

10. The method as claimed in claim 5, wherein
the first resolution and the third resolution are determined based on a network bandwidth associated with the first user terminal;
the third resolution is higher than the first resolution; and
a frame rate of the second image sequence is lower than a frame rate of the first image sequence.

11. The method as claimed in claim 5, wherein the transmitting the second image sequence comprises:
determining a temporary resolution associated with the second image sequence based on a network bandwidth associated with the first user terminal; and
increasing a resolution of the second image sequence from the temporary resolution to the third resolution and decreasing a frame rate of the second image sequence in response to determining that the temporary resolution is lower than a minimum resolution.

12. The method as claimed in claim 1, further comprising:
receiving a user input selecting a multi-party photo capturing button from the first user based on the entering the multi-party photo capturing mode;
capturing the first image using the image sensor, the first image including the first user;
receiving a second image from the second user terminal, the second image including the second user; and
generating a composite image by compositing the first image and the second image.

13. The method as claimed in claim 12, wherein a resolution of the composite image is higher than the first resolution.

14. The method as claimed in claim 12, further comprising:
transmitting the composite image to the second user terminal through the chat room.

15. The method as claimed in claim 12, further comprising:
generating metadata of a Voice over Internet Protocol (VoIP) call packet, the metadata including data corresponding to the composite image; and
transmitting the metadata to the second user based on the video call, the metadata being metadata in a protocol of a VoIP call channel connected to the first user and the second user.

16. The method as claimed in claim 1, wherein the entering the multi-party photo capturing mode comprises entering a specific sub-group among a plurality of sub-groups associated with multi-party photo capturing, the second user being included in a same specific sub-group as the first user.

17. The method as claimed in claim 1, wherein a maximum number of users associated with participation in multi-party photo capturing is less than a maximum number of users associated with participation in the video call.

18. The method as claimed in claim 1, further comprising:
displaying the first image sequence on a first area of a display of the first user terminal in response to determining that a number of users participating in the multi-party photo capturing mode is less than or equal to a first number of people, the displaying the first image sequence being performed based on the entering the multi-party photo capturing mode; and
displaying a second image sequence received from the second user terminal on a second area of the display.

19. A non-transitory computer-readable storage medium storing instructions that, when executed by at least one processor of a computer, cause the computer to perform the method of claim 1.

20. A first user terminal comprising:
a memory;
an image sensor; and
at least one processor connected to the memory and configured to execute at least one computer-readable program included in the memory to cause the first user terminal to,
initiate a video call between the first user terminal and a second user terminal, the first user terminal being associated with a first user, the second user terminal being associated with a second user, and the first user and the second user being included in a chat room of an instant messaging application,
transmit a first image sequence captured by the image sensor to the second user terminal during the video call, the first image sequence being transmitted at a first resolution,
enter a multi-party photo capturing mode during the video call, and
transmit a first image captured by the image sensor to the second user terminal in the multi-party photo capturing mode, the first image being transmitted at a second resolution different from the first resolution.
